(19) United States
(12) Patent Application Publication
(10) Pub. No.: US 2026/0170208 A1
(43) Pub. Date: Jun. 18, 2026

(54) NPN CANONIZATION OF BOOLEAN FUNCTIONS

(71) Applicant: International Business Machines Corporation, Armonk, NY (US)

(72) Inventors: Zoltan Tibor Hidvegi, Round Rock, TX (US); Zahraa Sabra, Atlanta, GA (US); Kevin Anthony Pasnik, Johnson City, TN (US); Paul Bunch, Austin, TX (US)

(73) Assignee: International Business Machines Corporation, Armonk, NY (US)

(21) Appl. No.: 18/979,881

(22) Filed: Dec. 13, 2024

(51) Int. Cl. G06F 30/32; G06F 111/10

(52) U.S. Cl. CPC G06F 30/32; G06F 2111/10

(57) ABSTRACT

In a computer-implemented technique of canonization, an input Boolean function having a single function output and a plurality of variables associated with function inputs is received. The variables are ordered to form variable partitions. A search for a Negation-Permutation-Negation (NPN) canonical form of the input Boolean function is performed. The searching includes dynamically limiting a search space by constructing symmetry groups in the variable partitions during the searching. The NPN canonical form of the input Boolean function is then stored in data storage.

### BACKGROUND OF THE INVENTION

The present invention relates in general to integrated circuit design, and more specifically, to Boolean logic optimization through Negation-Permutation-Negation (NPN) canonization.

Boolean functions, which are fundamental to digital logic circuits, can be represented in various different forms. Current Electronic Design Automation (EDA) tools seek to implement standardized or canonical forms of particular Boolean functions, for example, in the context of logic synthesis and/or functional verification. The process of transforming Boolean functions to obtain standardized or canonical forms is referred to in the art as “canonization.”

### SUMMARY OF THE INVENTION

In one or more embodiments, a computer-implemented technique of canonization can be implemented as a method, computer program product, and/or data processing system.

According to one or more embodiments, an input Boolean function having a single function output and a plurality of variables associated with function inputs is received. The variables are ordered to form variable partitions. A search for a Negation-Permutation-Negation (NPN) canonical form of the input Boolean function is performed. The searching includes dynamically limiting a search space by constructing symmetry groups in the variable partitions during the searching. The NPN canonical form of the input Boolean function is then stored in data storage.

According to one or more embodiments, a NPN canonization technique for an input Boolean function having a single function output and a plurality of function inputs includes ordering a plurality of variables associated with the plurality of function inputs in a first phase of processing. The ordering includes forming variable partitions of the plurality of variables. In a second phase of processing, a search is performed for a Negation-Permutation-Negation (NPN) canonical form of the input Boolean function. The searching includes dynamically limiting a search space by constructing symmetry groups in the variable partitions during the searching. The NPN canonical form of the input Boolean function is then stored in data storage and can be utilized to transform a digital circuit design by replacing a target Boolean function in the digital circuit design with the NPN canonical form.

### BRIEF DESCRIPTION OF THE DRAWINGS

FIG. 1 is a high-level block diagram of an exemplary data processing environment in accordance with one or more embodiments;

FIG. 2 is a high-level logical flowchart of an integrated circuit design, verification, and fabrication process in accordance with one or more embodiments;

FIG. 3 is a high-level diagram of an exemplary canonization process in accordance with one or more embodiments; and

FIG. 4 is a high-level logical flowchart of an exemplary canonization process in accordance with one or more embodiments.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

In one or more embodiments, a computer-implemented method of canonization includes processing circuitry of a computer receiving an input Boolean function having a single function output and a plurality of variables associated with function inputs. The processing circuitry orders the variables to form variable partitions. The processing circuitry searches for a Negation-Permutation-Negation (NPN) canonical form of the input Boolean function. The searching includes dynamically limiting a search space by constructing symmetry groups in the variable partitions during the searching. The processing circuitry stores, in data storage, the NPN canonical form of the input Boolean function. The disclosed embodiments accelerate processing of Boolean functions, for example, in an integrated circuit design process, by finding a single NPN canonical form representing all Boolean functions in a function group. The limitation of the search space enables the NPN canonical form to be found with use of fewer resources, including processing resources and processing time.

In one or more embodiments of a method, the ordering of variables to form variable partitions includes breaking ordering ties between variables using coefficients for complement sets. Breaking ordering ties utilizing coefficients for complement sets enables mutual ordering of variables to be resolved in cases in which other ordering metrics, such as the Hadamard-Walsh coefficients of the variables, do not establish a defined ordering.

In one or more embodiments of a method, the ordering of variable to form variable partitions includes ordering multiple variables among the plurality of variables in accordance with respective impact function values of the multiple variables. Ordering variables by the impact function enables mutual ordering of variables to be resolved in cases in which other ordering metrics, such as the Hadamard-Walsh coefficients of the variables, do not establish a defined ordering.

In one or more embodiments of a method, the ordering is refined by subdividing variable partitions. In some examples, the variable partitions are formed in accordance with the Hadamard-Walsh coefficients of the variables. In some examples, the variables of the variable partitions may further be ordered in accordance with an impact function. Subdividing variable partitions in this manner accelerates subsequent search for the NPN canonical form the Boolean function.

In one or more embodiments of a method, the search for the NPN canonical form of the Boolean function is terminated based on identifying symmetry in all remaining permutations and inversions in a variable partition. Terminating the search based on this condition reduces the resources consumed by the search process.

In one or more embodiments of a method, a digital circuit design is transformed by replacing an instance of the input Boolean function in the integrated circuit design with the NPN canonical form. This transformation enables a standardized or optimized Boolean function to be employed in a digital design process in place of a group of related Boolean functions. As a result, electronic design automation (EDA) processing steps, such as logical verification and logic synthesis, can be accelerated, design performance can be improved, and design errors can be reduced.

In one or more embodiments, a computer-implemented method of NPN canonization of an input Boolean function having a single function output and a plurality of function inputs includes processing circuitry ordering a plurality of variables associated with a plurality of function inputs of an input Boolean function in a first phase of processing. The ordering includes forming variable partitions of the plurality of variables. In a second phase of processing, the processing circuitry searches for a Negation-Permutation-Negation (NPN) canonical form of the input Boolean function. The searching includes dynamically limiting a search space by constructing symmetry groups in the variable partitions during the searching. The processing circuitry stores, in data storage, the NPN canonical form of the input Boolean function and transforms a digital circuit design by replacing a target Boolean function in the digital circuit design with the NPN canonical form. This method accelerates electronic design automation (EDA) processing steps, such as logical verification and logic synthesis, optimizes performance of the digital circuit design, and reduces design errors.

In one or more embodiments of a method, transforming the digital circuit design includes transforming the digital circuit design during logical verification. By replacing the target Boolean function with the NPN canonical form, verification of the digital logical design can be accelerated.

In one or more embodiments of a method, transforming the digital circuit design includes transforming the digital circuit design during logic synthesis. By replacing the target Boolean function with the NPN canonical form, the performance of the digital logical design can be optimized.

In one or more embodiments, a computer program product includes a storage device and program code stored within the storage device and executable by processing circuitry of a computer to perform operations. The operations include receiving an input Boolean function having a single function output and a plurality of variables associated with function inputs. The variables are ordered to form variable partitions. A search is performed for a Negation-Permutation-Negation (NPN) canonical form of the input Boolean function. The search space is dynamically limited by constructing symmetry groups in the variable partitions during the searching. The NPN canonical form of the input Boolean function is stored in data storage. The disclosed embodiments accelerate processing of Boolean functions, for example, in an integrated circuit design process, by finding a single NPN canonical form representing all Boolean functions in a function group. The limitation of the search space enables the NPN canonical form to be found with use of fewer resources, including processing resources and processing time.

In one or more embodiments of a computer program product, the ordering of variables to form variable partitions includes breaking ordering ties between variables using coefficients for complement sets. Breaking ordering ties utilizing coefficients for complement sets enables mutual ordering of variables to be resolved in cases in which other ordering metrics, such as the Hadamard-Walsh coefficients of the variables, do not establish a defined ordering.

In one or more embodiments of a computer program product, the ordering of variable to form variable partitions includes ordering multiple variables among the plurality of variables in accordance with respective impact function values of the multiple variables. Ordering variables by the impact function enables mutual ordering of variables to be resolved in cases in which other ordering metrics, such as the Hadamard-Walsh coefficients of the variables, do not establish a defined ordering.

In one or more embodiments of a computer program product, the ordering is refined by subdividing variable partitions. In some examples, the variable partitions are formed in accordance with the Hadamard-Walsh coefficients of the variables. In some examples, the variables of the variable partitions may further be ordered in accordance with an impact function. Subdividing variable partitions in this manner accelerates subsequent search for the NPN canonical form the Boolean function.

In one or more embodiments of a computer program product, the search for the NPN canonical form of the Boolean function is terminated based on identifying symmetry in all remaining permutations and inversions in a variable partition. Terminating the search based on this condition reduces the resources consumed by the search process.

In one or more embodiments of a computer program product, a digital circuit design is transformed by replacing an instance of the input Boolean function in the integrated circuit design with the NPN canonical form. This transformation enables a standardized or optimized Boolean function to be employed in a digital design process in place of a group of related Boolean functions. As a result, electronic design automation (EDA) processing steps, such as logical verification and logic synthesis, can be accelerated, design performance can be improved, and design errors can be reduced.

In one or more embodiments, a computer program product includes a storage device and program code stored within the storage device and executable by processing circuitry of a computer to perform NPN canonization of an input Boolean function having a single function output and a plurality of function inputs through operations. The operations include ordering a plurality of variables associated with a plurality of function inputs of an input Boolean function in a first phase of processing. The ordering includes forming variable partitions of the plurality of variables. The operations include, in a second phase of processing, searching for a Negation-Permutation-Negation (NPN) canonical form of the input Boolean function. The searching includes dynamically limiting a search space by constructing symmetry groups in the variable partitions during the searching. The operations include storing, in data storage, the NPN canonical form of the input Boolean function and transforming a digital circuit design by replacing a target Boolean function in the digital circuit design with the NPN canonical form. The computer program product accelerates electronic design automation (EDA) processing steps, such as logical verification and logic synthesis, optimizes performance of the digital circuit design, and reduces design errors.

In one or more embodiments of a computer program product, transforming the digital circuit design includes transforming the digital circuit design during logical verification. By replacing the target Boolean function with the NPN canonical form, verification of the digital logical design can be accelerated.

In one or more embodiments of a computer program product, transforming the digital circuit design includes transforming the digital circuit design during logic synthesis. By replacing the target Boolean function with the NPN canonical form, the performance of the digital logical design can be optimized.

In one or more embodiments, a data processing system includes processing circuitry, a storage device coupled to the processing circuitry, and program code stored within the storage device and executable by the processing circuitry of a data processing system to perform operations. The operations include receiving an input Boolean function having a single function output and a plurality of variables associated with function inputs. The variables are ordered to form variable partitions. A search is performed for a Negation-Permutation-Negation (NPN) canonical form of the input Boolean function. The search space is dynamically limited by constructing symmetry groups in the variable partitions during the searching. The NPN canonical form of the input Boolean function is stored in data storage. The disclosed embodiments accelerate processing of Boolean functions, for example, in an integrated circuit design process, by finding a single NPN canonical form representing all Boolean functions in a function group. The limitation of the search space enables the NPN canonical form to be found with use of fewer resources, including processing resources and processing time.

In one or more embodiments of a data processing system, the ordering of variables to form variable partitions includes breaking ordering ties between variables using coefficients for complement sets. Breaking ordering ties utilizing coefficients for complement sets enables mutual ordering of variables to be resolved in cases in which other ordering metrics, such as the Hadamard-Walsh coefficients of the variables, do not establish a defined ordering.

In one or more embodiments of a data processing system, the ordering of variable to form variable partitions includes ordering multiple variables among the plurality of variables in accordance with respective impact function values of the multiple variables. Ordering variables by the impact function enables mutual ordering of variables to be resolved in cases in which other ordering metrics, such as the Hadamard-Walsh coefficients of the variables, do not establish a defined ordering.

In one or more embodiments of a data processing system, the ordering is refined by subdividing variable partitions. In some examples, the variable partitions are formed in accordance with the Hadamard-Walsh coefficients of the variables. In some examples, the variables of the variable partitions may further be ordered in accordance with an impact function. Subdividing variable partitions in this manner accelerates subsequent search for the NPN canonical form the Boolean function.

In one or more embodiments of a data processing system, the search for the NPN canonical form of the Boolean function is terminated based on identifying symmetry in all remaining permutations and inversions in a variable partition. Terminating the search based on this condition reduces the resources consumed by the search process.

In one or more embodiments of a data processing system, a digital circuit design is transformed by replacing an instance of the input Boolean function in the integrated circuit design with the NPN canonical form. This transformation enables a standardized or optimized Boolean function to be employed in a digital design process in place of a group of related Boolean functions. As a result, electronic design automation (EDA) processing steps, such as logical verification and logic synthesis, can be accelerated, design performance can be improved, and design errors can be reduced.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

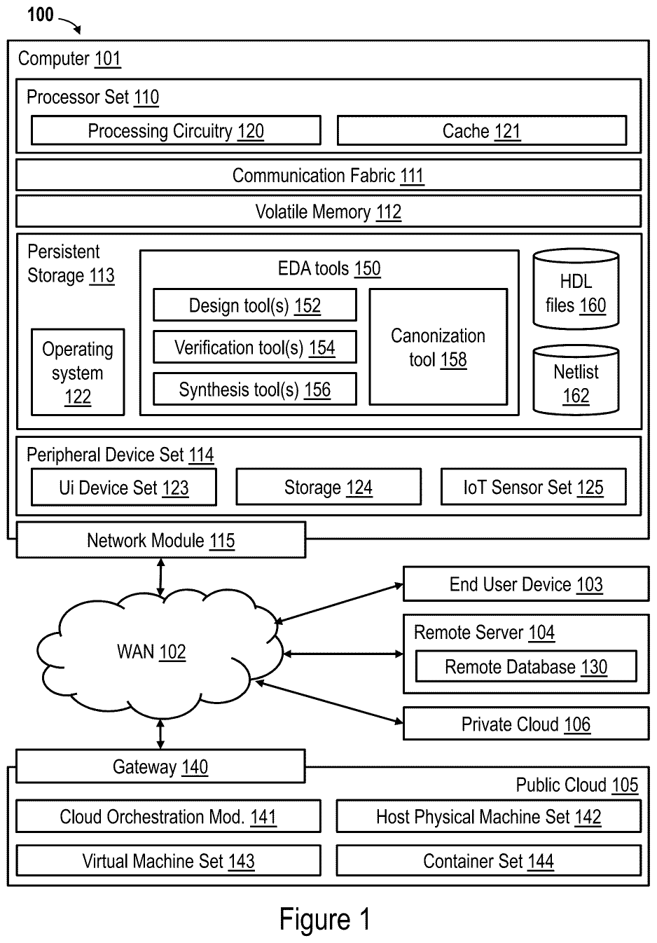

With reference now to FIG. 1, computing environment 100 contains an example of an environment for the execution of at least some of the computer code, such as electronic design automation (EDA) tools 150, involved in performing the inventive methods. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and other code and data), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be implemented in EDA tools 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in EDA tools 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet-of-Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the Internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Those of ordinary skill in the art will appreciate that the architecture and components of a data processing environment can vary between embodiments. Accordingly, the exemplary computing environment 100 given in FIG. 1 is not meant to imply architectural limitations with respect to the claimed invention.

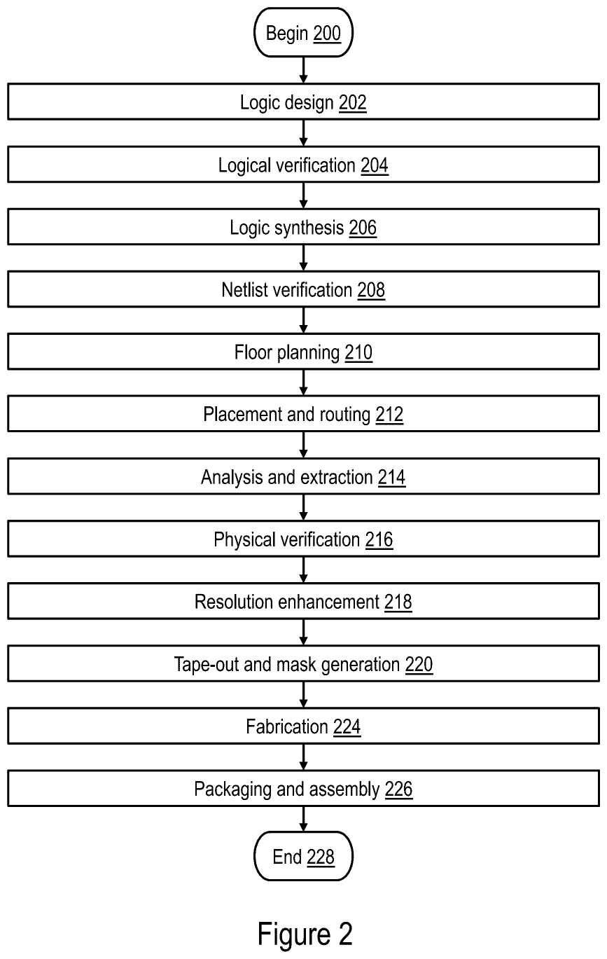

Referring now to FIG. 2, there is depicted a high-level logical flowchart of an integrated circuit design, verification, and fabrication process in accordance with one or more embodiments. The depicted process may be performed, in part, through the use of EDA tools 150, which may include, for example, design tool(s) 152, verification tool(s) 154, synthesis tool(s) 156, and canonization tool 158. Those skilled in the art will appreciate that many of the steps of the depicted process can be performed contemporaneously and/or in a different order than illustrated, and further, may be performed iteratively. It will also be appreciated that for large-scale designs, it is typical for the overall design to be decomposed into multiple smaller units or entities, for which many of the illustrated steps can be separately performed. In the industry, it is also common for multiple parties to separately perform at least some of the illustrated steps and combine the separate work of the multiple parties through inter-party licensing of intellectual property (IP) blocks and/or contract manufacturing.

The process of FIG. 2 begins at block 200 and then proceeds to bock 202, which illustrates a logic design step 202. In step 202, human and/or automated (e.g., artificial intelligence (μl)) circuit designer(s) may specify an initial design for an integrated circuit using one or more design tool(s) 152. The specification for the integrated circuit may be expressed, for example, within hardware description language (HDL) files 160 utilizing a HDL such as Very High Speed Integrated Circuit Hardware Description Language (VHDL), Verilog, SystemVerilog, SystemC, MyHDL or OpenVera. Those skilled in the art will appreciate that EDA tools 150 may transform the HDL description into one or more lower level design description such as a logic-level RTL description, a gate-level description, a layout-level description, or a mask-level description. Each succeeding lower level of design representation provides more specific details for a particular integrated circuit implementation of the design. During logic design step 202, the design can be decomposed into different entities or units to facilitate parallelization of the design effort and modular processing at subsequent design steps.

After a specification of the logical design is developed at logic design step 202, one or more verification tool(s) 154 are executed to verify the logical correctness of the logic design at logical verification step 204. The verification tool(s) 154 may include, for example, simulators, testbench generators, static HDL checkers, and formal verification tools. Synthesis tool(s) 156 can additionally be executed to transform the logic design represented in HDL files 160 into a netlist 162 in a logic synthesis step 206.

In a typical implementation, a netlist is a directed graph including a plurality of nodes representing “gates” and a plurality of edges representing “wires” (or “nets” or “signals”) between the gates. Gates have associated functions, such as constants, primary inputs, combinational logic (e.g., AND, OR, etc.) and sequential elements (e.g., latches or registers). Hereafter, all sequential elements are referred to as “registers” for brevity. Certain gates are labeled as “primary outputs” of the netlist, which along with primary inputs represent interconnections to other logic components. Logic synthesis step 206 generally must preserve the behavior of primary outputs relative to primary inputs.

Generally, a netlist 162 can support arbitrary gate types with an arbitrary number of input and output pins. However, in some exemplary embodiments, netlist 162 is an AND/Inverter graph in which combinational gates are implemented with simple two-input AND gates, and inversions are implicit attributes of edges. In some cases, different netlist formats are utilized in different steps or stages of the integrated circuit design process. Typically, each different netlist format supports a respective fixed set of gate types. Typically, in a design-compilation flow for synthesis or for verification, netlists begin with higher-level gates (e.g., vectored multiplexors and adders). Subsequently, during compilation/model-build flow, the netlist gates are gradually decomposed into smaller, simpler gates, allowing fine-grained optimizations.

Following step logic synthesis step 206, EDA tools 150 can be executed to perform a netlist verification step 208. In netlist verification, EDA tools 150 verify compliance of the netlist for correspondence to the design specified by the HDL files 160 and for compliance with any timing constraints of the design.

EDA tools 150 can then be executed to develop an implementation of the design as a physical integrated circuit. The development of the integrated circuit can begin with a floor planning step 210 in which a basic floor plan for the units and routing for the integrated circuit is constructed. Developing on the high-level physical layout provided by the floor plan, a more detailed physical layout is developed in placement and routing step 212. In step 212, standard cells, individual circuit components (e.g., transistors and capacitors), and routing are physically placed within the integrated circuit floorplan.

EDA tools 150 can additionally be executed to validate circuit function in an analysis and extraction step 214. In physical verification step 216, EDA tools 150 also verify satisfaction of manufacturing constraints, such as design rule check (DRC) constraints, power constraints, lithography constraints, etc., and further check that the integrated circuit conforms to the HDL design specification. EDA tools 150 further improve the geometry of the physical layout for purpose of manufacturing in a resolution enhancement step 218. Based on the final geometry determined at step 218, EDA tools 150 can generate, in tape-out and mask generation step 220, data sets detailing the design for lithographic masks utilized to fabricate the integrated circuit.

Following tape-out and mask generation step 220, lithographic masks can be utilized to fabricate integrated circuit chips in fabrication step 224. These integrated circuit chips can then be packaged and assembled on circuit cards and/or circuit boards, as depicted in packaging and assembly step 226. Thereafter, the process of FIG. 2 ends at block 228.

The inventions disclosed herein, which may be implemented in one or more EDA tools 150, such as verification tool(s) 154 and/or synthesis tool(s) 156 and/or canonization tool 158, facilitate the NPN canonization of one or more Boolean functions present in an electronic design. Canonization can be implemented in EDA tools 150 to guarantee single, standardized representation for each unique Boolean function, thus facilitating comparison, analysis, and/or logic synthesis. Canonization also accelerates time-consuming design steps, such as logic synthesis, by reducing all variants of a Boolean function appearing in a logic design into a common optimized form. While not directly a minimization technique, canonization can be a precursor to further optimization efforts, such as Karnaugh maps or Quine-McCluskey algorithms.

Because negation and permutation are cost-less operations in logic synthesis and functional verification, EDA tools commonly employ NPN canonization to obtain canonical forms of Boolean functions. Each Boolean function that is a member of a classification represented by a unique representative canonical form can be obtained from all of the other Boolean member functions of that classification through various combinations of one or more of three transformations: negation of the input(s), permutation of the input(s), and/or negation of the output.

The Walsh transform, a mathematical tool for analyzing functions in terms of orthogonal basis functions, is one known approach to NPN canonization. To apply the Walsh transform, a Boolean function is mathematically represented as a vector of its truth table values. The Walsh transform of this vector yields a new vector, in which each element corresponds to a Walsh coefficient. The Walsh coefficients can then be interpreted as the amplitudes of different frequency components of the function. By examining the Walsh coefficients and their corresponding Walsh functions, it is possible to extract the NPN canonical form of the function. Although the Walsh transform is a promising approach for NPN canonization, current methods require lengthy runtimes to find the tightest classifications and smallest inversion sets needed for NPN canonization. There is therefore a continuing need for improvement in existing NPN canonization techniques.

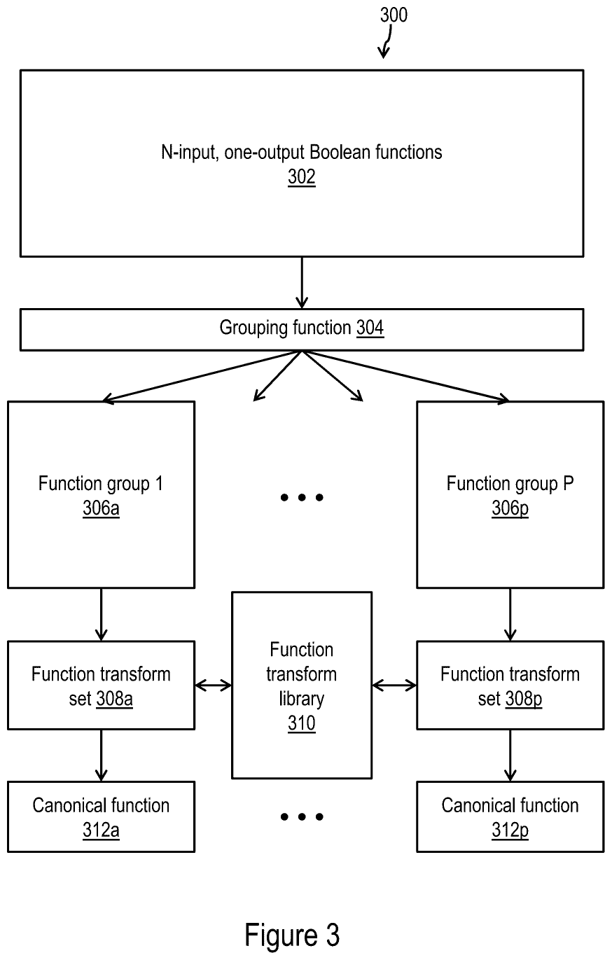

FIG. 3 illustrates a high-level flow diagram of an exemplary NPN canonization process 300 in accordance with one or more embodiments. NPN canonization process 300 begins with a collection of N-input, one-output Boolean functions 302. A grouping function 304 can be utilized to assign each of Boolean functions 302 to one of P function groups 306a to 306p. Function groups 306 are selected such that the member functions of each function group 306 can be represented by a single NPN canonical function 312a to 312p. Thus, for example, all member functions of function group 1 306a can be implemented, with appropriate input inversions and permutations, by canonical function 312a, and all member functions of function group 306p can be implemented, with appropriate input inversions and permutations, by canonical function 312p. Canonization process 300 determines not only the respective canonical function 312 representing the member functions of each function group 306, but also the sets of function transforms (i.e., function transform sets 308a to 308p) that transforms the member functions of function groups 306 to obtain the respective canonical functions 312. These function transform sets 308 can be stored in a function transform library 310 to enable rapid canonization of any arbitrary N-input, one-output Boolean function 302, for example, during logical verification step 204 or logic synthesis step 206 of FIG. 2.

In accordance with one or more embodiments, a canonization process for a given Boolean function 302 can be implemented in two main phases. In a first phase, the canonization process orders variables and finds canonical variable inversions based at least in part on the Hadamard-Walsh spectrum. If the Boolean function has an NPN symmetry that moves one variable to another, then this method will not be able to differentiate between these variables. Similarly, if there is a symmetry that inverts a variable, then the Hadamard-Walsh spectrum alone is not able to decide if a variable should be inverted or not.

Based on the Hadamard-Walsh spectrum, it is possible to partition the variables into variable groups that permit symmetries to move each variable within a variable group to another variable within the same variable group and that identify a set of variables that a symmetry may invert. In the best case, these variable groups and the undecided inversion set will be the smallest possible based on the symmetries of the function, but finding the tightest variable groups and smallest inversion set can be expensive. The canonization process preferably optimizes the grouping of the variables in the variable groups in most cases without excessive runtime. During the process of variable grouping, the canonization process preferably does not calculate the entire Hadamard-Walsh spectrum, which has 2ⁿ coefficients, but instead uses higher-order coefficients to break ties and thus reach a NPN canonical form faster than conventional canonization algorithms.

After identification of the variable groups and a set of undecidable inversions, if any, the canonization process preferably enters a second phase in which the canonization process loops through the input permutations and inversions allowed by the variable groups and finds the minimal Boolean function according to some complete ordering. The minimal Boolean function represents the NPN canonical form. In at least some embodiments, this loop will also construct the symmetry group of the Boolean function and uses the symmetry group to cut down the search space for the NPN canonical form. Trimming the search space in this way makes the search for the NPN canonical form fast even for highly symmetrical functions. This canonization process can detect and use any complex symmetries rather than just pairwise swaps.

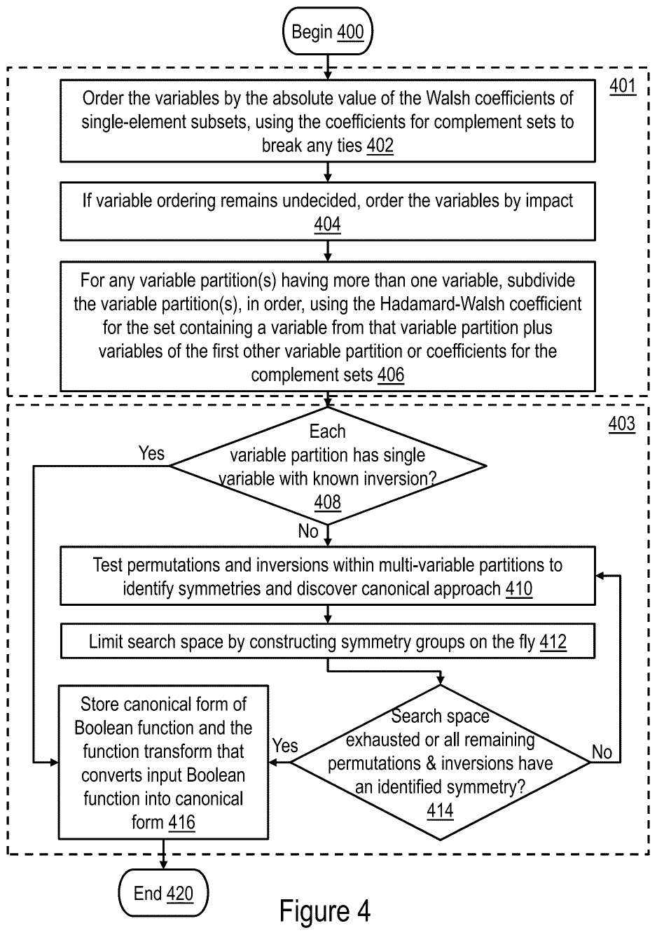

Referring now to FIG. 4, there is depicted a high-level logical flowchart of an exemplary canonization process in accordance with one or more embodiments. The illustrated process can be implemented, for example, through execution of canonization tool 158 by processing circuitry 120.

The process of FIG. 4 begins at block 400 and then proceeds to block 401, which illustrates a first phase of the canonization process in which variables of the Boolean function are ordered based on the Hadamard-Walsh spectrum.

In computing the Hadamard-Walsh spectrum, the set of variables of the Boolean equation to be canonized can be denoted V={v₀, . . . , vₙ₋₁}. For each subset S⊂V, the Hadamard-Walsh spectral coefficient is computed. Subsets of variables are represented by numbers N(S)=Σ_{{i:vi∈S}}2ⁱ, where the base-2 place values represent the variables, with a 1 digit for each variable in S and a 0 digit otherwise. The kth spectral base is bₖ(x)=(−1)^{popct(k&x)}, where k&x is the bitwise AND of k and x. It should be noted that the norm (i.e., the square root of the sum of squares) of this base is \sqrt{n} and would accordingly be required to be divided by \sqrt{n} to obtain an orthonormal base. In a preferred embodiment, this division can be omitted because only the sign and relative ordering of coefficients are of interest. Consequently, non-normalized integer valued coefficients can be employed. The Boolean function ƒ is also defined on integers 0, . . . , 2ⁿ−1. In calculating the Hadamard-Walsh spectrum, −1 represents false and +1 represents true. Thus, ƒ(x)∈{−1, +1} for each integer 0≤x<2ⁿ. The kth Hadamard-Walsh spectral coefficient is then:

$${w}_{k} ( f ) = {\sum }_{x = 0}^{2 \hat{} N - 1} {b}_{k} ( x ) f ( x )$$

for each 0≤k<2ⁿ. If bₖ and ƒ are represented as 2ⁿ-bit binary numbers where the xth digit of bₖ is 0 when bₖ(x)=1 and is 1 when bₖ(x) is −1 and the xth digit of ƒ is 1 iff ƒ(x) true, then the Hadamard-Walsh spectral coefficients can be calculated as:

$${w}_{k} ( f ) = 2 popct ( {b}_{k} ⊕ f ) - {2}^{n}$$

where ⊕ is the bitwise XOR operator. Because the result of this function is always even, code can be optimized by using half of the result to calculate the k coefficient. In at least some implementations, the k coefficient can be calculated very efficiently by calculating the exclusive-OR of two registers and the popcount of a register using single-cycle machine instructions. The bₖ spectral base values can be pre-calculated once during initialization.

First order spectral coefficients are the ones corresponding to single element variable sets, i.e., wₖ where popct(k)=1 and k is a positive integer power of 2. Similarly, second order spectral coefficients have two variables, third order spectral coefficients have three variables, etc. It should be noted that the 0^{th} coefficient w₀(ƒ) is negative if ƒ is false for more values than it is true (i.e., if the number of is 1 s less than 2ⁿ⁻¹). Inverting ƒ negates all spectral coefficients. Inverting a variable negates all spectral coefficients corresponding to variable sets containing the variable, a fact that facilitates finding canonical inversions for input variables. Permuting inputs permutes spectral coefficients without changing their signs and magnitudes, a fact that can be leveraged to find a canonical ordering of inputs.

In first phase 401, canonization tool 158 can first initially order the variables of the input Boolean function and then refine the variable ordering. In at least one embodiment, the variables are first ordered by the absolute value of the Hadamard-Walsh spectrum coefficients, with the coefficients for complement sets being used to break any ties (block 402). If the variable ordering remains undecided, variables can be ordered from greatest to least according to impact, with the impact of a variable being defined as the number of configurations for all other variables for which the output value flips when the value of the selected variable is flipped (block 404).

In at least one embodiment, the initial ordering depicted at blocks 402-404 can be implemented by canonization tool 158 as follows. First, let M=2ⁿ−1. In addition, let ƒᵢ be the n−1 variable function obtained from ƒ when vᵢ is tied to 1, and ƒᵢ be the function when vᵢ is tied to 0. Function ƒ can then be uniquely decomposed into two n−1 variable functions as follows:

$$f ( x ) = {v}_{i} ( {f}_{i} ⊕ {f}_{\overline{1}} ) ( y ) ⊕ {f}_{\overline{1}} ( t ) ,$$

where y is obtained from x by removing the ith variable and ⊕ is the XOR operator. The impact function for variable vᵢ, which can be denoted as Iᵢ=ƒᵢ⊕ƒᵢ, is an n−1 variable function which is true iff changes value when vᵢ flips from 0 to 1. It should be note that Iᵢ does not change when ƒ is inverted or when the input vᵢ is inverted. With these definitions, the initial ordering can be determined as follows:
1. Invert the whole function ƒ if w₀(ƒ)>0, so that ƒ is true for no more than half of the possible inputs.
2. Invert each input variable vᵢ for which w_{2\hat{ }i}(ƒ)>0.
3. If w_{2\hat{ }i}(ƒ)=0 but w_{M}(ƒ)≠0 and w_{M-2\hat{ }i}(ƒ)≠0 then invert vᵢ as needed to set the sign of w_{2\hat{ }i}(ƒ) to be the same as the sign of w_{M}(ƒ).
4. Order the variables so that the magnitude of the first order coefficients are increasing, i.e. w_{2\hat{ }i}(ƒ)≤w_{2\hat{ }i}(ƒ) if i<j.
5. If the order of two variables is undecided, use the magnitude of w_{M-2\hat{ }i}(ƒ) to break ties.
6. If the order is still undecided, order variables according to increasing impact Iᵢ, i.e. the number of inputs combinations for the variable set excluding vᵢ where ƒ changes value when vᵢ changes value. Note that the impact does not change when a variable is inverted and therefore cannot be used to decide the canonical inverted state.

The initial ordering of variables can thus be based on Hadamard-Walsh spectrum coefficients or impact values. However, sometimes two or more variables have the same Hadamard-Walsh spectrum coefficient, and the impact value cannot be used to decide ordering. For example, for variables a, b, c, d having Hadamard-Walsh spectrum coefficients 0, 1, 1, and 2, respectively, the following variable partitions can be defined: {a}, {b,c}, {d}. In this case, it is known that a<b<d and a<c<d, but the relative ordering between b and c is undetermined. Following the initial ordering at blocks 402-404, the variables are thus grouped in variable partitions in accordance with Hadamard-Walsh spectrum coefficients, where the first few partitions with w_{2\hat{ }i}(ƒ)=0 may have undecided inverted states. Within a variable partition, either all variables have a known inverted state or none of the variables has a known inverted state, and the order of variables within a partition is undecided.

The initial ordering can then be refined. In one or more embodiments, the initial ordering is refined by reference to variable partitions, as shown in block 406. In one or more embodiments, the ordering refinement depicted at block 406 can be implemented as follows. Let H be a variable partition that either includes multiple variables or an undecided inverted state. The ordering and inversions of each variable partition H having undecided ordering or inversions can be refined using another partition G (G≠H) as follows:
1. For each h∈H, first use the magnitude of w_{GU{h}}(ƒ) to order H.
2. If the inverted state of G is known but the inverted state of H is unknown, then invert h if w_{GU{h}}(ƒ)<0. If w_{GU{h}}(ƒ) is zero, then the inverted state of h remains undecided.
3. If the variable order is still unknown, order H according to w_{M\G\{h}}(ƒ).
4. If w_{M}≠0, the inversions of G are known, and w_{M\G\{h}}≠0, then invert h as needed to match the sign of w_{M} and w_{M\G\{h}}.

If this ordering refinement process succeeds in refining the ordering and/or inversions of some of the variable partitions but undecided partitions remain, the ordering refinement process can be repeated iteratively using only the variable partitions that have changed since the last step of the prior iteration in order to avoid duplicate calculations. This iteration can continue until no additional order refinement is found.

At this point in the canonization process, obtaining further refinements using more spectral coefficients is possible, and may be successful in some cases. However, at this point in the canonization process, most of the undecided variable ordering and inversions are due to symmetries. Consequently, processing efficiency is improved by proceeding at this point to identifying symmetries rather than seeking to continue breaking ordering ties using Hadamard-Walsh spectrum processing. Accordingly, the process of FIG. 4 preferably proceeds to a second phase 403 of processing in which symmetries are identified and a preferred NPN canonical form is determined. An exemplary embodiment of second phase 403 includes blocks 408 to 416.

Block 408 illustrates canonization tool 158 determining whether or not each variable partition has a single variable with a known inversion. In response to an affirmative determination at block 408, the canonization process of FIG. 4 passes to block 416, which is described below. In response to a negative determination at block 408, canonization tool 158 tests the permutations and inversions of variables within each multi-variable partition in order to identify symmetries between variables and discover a preferred canonical form (i.e., the minimal NPN representation when interpreting the input Boolean function as a 2^{2\hat{ }n}-bit binary integer) (block 410). As indicated at block 412, canonization tool 158 limits the search space applied at block 410 by constructing symmetry groups on the fly. The operations performed at blocks 410-412 continue iteratively until canonization tool 158 determines at block 414 that the search space has been exhausted or all remaining permutations and inversions have an identified symmetry (block 414). In response to canonization tool 158 determining at block 414 that the search space has been exhausted or all remaining permutations and inversions have an identified symmetry, the process of FIG. 4 proceeds to block 416.

Block 416 illustrates canonization tool 158 storing the NPN canonical form of the Boolean function and the function transform that converts the input Boolean function into the NPN canonical form. For example, canonization tool 158 may store the function transform in function transform library 310 to accelerate the subsequent transformation of other instances of the input Boolean function. Following block 416, the canonization process of FIG. 4 ends at block 420.

In some embodiments, canonization tool 158 implements a permutation library that can represent combinations of permutations and inversions efficiently using integers where each unique integer representation represents a corresponding permutation and/or inversion operating on any number of inputs, with numbers less than 2ⁿnl representing permutations/inversions operating on up to n inputs. Permutations/inversions can be multiplied (composed), inverted, or applied to a Boolean function, array or bit set. The permutation library can also represent permutation/inversion groups using O(n²) storage. The permutation/inversion groups can be stored in a canonical format and placed in a hash table, and a pointer to a permutation/inversion group stored in the hash table can be used to represent the permutation/inversion group. Group operations, such as extending a group by adding new generators, union, intersection, enumeration of coset pins, etc., can also be advantageously supported in at least some embodiments.

One exemplary implementation of the operations depicted at block 410 can be as follows. Let L represent the group of permutations that move inputs within their undecided variable partitions and inverts inputs that have undecided inversions. The size of this group is given by:

$$\vert L \vert = {2}^{j} {\prod }_{G ∈ U} \vert G \vert !$$

where U is the set of input sets where the order of variables are undecided after the first phase and j is the number of inputs with undecided inversions.

At the beginning of the search, the symmetry group contains the identity. Canonization tool 158 then iterates through all permutations and inversions compatible with the previously established partitions. This processing can be done efficiently by either inverting a single variable or swapping two variables during each iteration. Canonization tool 158 records the minimal function found during this process, and if it finds a symmetry, adds the symmetry to the symmetry group. With a symmetry group S of size k, it is sufficient to consider the |L|/k number of coset pins of S in L. If the number of coset pins is less than the number of permutations remaining in the current search, canonization tool 158 restarts the search using just these coset pins. This reduction of the search space as shown at block 412 enables the rapid construction of the full symmetry group of highly symmetrical functions and significantly accelerates the search for the canonical NPN representation of the input Boolean function.

As has been described, a computer-implemented technique of canonization can be implemented as methods, computer program products, and/or data processing systems.

According to one or more embodiments, an input Boolean function having a single function output and a plurality of variables associated with function inputs is received. The variables are ordered to form variable partitions. A search for a Negation-Permutation-Negation (NPN) canonical form of the input Boolean function is performed. The searching includes dynamically limiting a search space by constructing symmetry groups in the variable partitions during the searching. The NPN canonical form of the input Boolean function is then stored in data storage.

According to one or more embodiments, a NPN canonization technique for an input Boolean function having a single function output and a plurality of function inputs includes ordering a plurality of variables associated with the plurality of function inputs in a first phase of processing. The ordering includes forming variable partitions of the plurality of variables. In a second phase of processing, a search is performed for a Negation-Permutation-Negation (NPN) canonical form of the input Boolean function. The searching includes dynamically limiting a search space by constructing symmetry groups in the variable partitions during the searching. The NPN canonical form of the input Boolean function is then stored in data storage and can be utilized to transform a digital circuit design by replacing a target Boolean function in the digital circuit design with the NPN canonical form.

While the present invention has been particularly shown as described with reference to one or more preferred embodiments, it will be understood by those skilled in the art that various changes in form and detail may be made therein without departing from the spirit and scope of the invention.

The following definitions are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, system or apparatus that comprises a list of elements is not necessarily limited to only those elements but can include other elements not expressly listed or inherent to such composition, mixture, process, method, article, system or apparatus.

Additionally, the term “exemplary” is used herein to mean “serving as one example, instance or illustration.” Any embodiment or design described herein as “exemplary” is not necessarily to be construed as preferred or advantageous over other embodiments or designs. The terms “at least one” and “one or more” shall be understood to include any integer number greater than or equal to one, and the term “plurality” shall be understood to include any integer number greater than or equal to two. The term “coupled” shall include both indirect connection and a direct connection, unless specified otherwise in a particular case. The terms “about,” “substantially,” “approximately,” and variations thereof, are intended to include the degree of error associated with measurement of the particular quantity based upon the equipment available at the time of filing the application. For example, “about” can include a range of ±10% or ±5%, or ±2% of a given value.

The figures described herein and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. For the sake of brevity, conventional techniques related to making and using aspects of the invention(s) may or may not be described in detail herein, and many conventional implementation details are only mentioned briefly or are omitted entirely. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a” is not intended as limiting of the number of items.

What is claimed is:

1. A computer-implemented method of canonization, the method comprising:
processing circuitry of a computer receiving an input Boolean function having a single function output and a plurality of variables associated with function inputs;
the processing circuitry ordering the variables to form variable partitions;
the processing circuitry searching for a Negation-Permutation-Negation (NPN) canonical form of the input Boolean function, wherein the searching includes dynamically limiting a search space by constructing symmetry groups in the variable partitions during the searching; and
the processing circuitry storing, in data storage, the NPN canonical form of the input Boolean function.

2. The method of claim 1, wherein:
the ordering includes breaking ordering ties between variables using coefficients for complement sets.

3. The method of claim 1, wherein:
the ordering includes ordering multiple variables among the plurality of variables in accordance with respective impact function values of the multiple variables.

4. The method of claim 1, further comprising:
refining ordering by subdividing variable partitions.

5. The method of claim 1, wherein the searching includes:
terminating the searching based on identifying symmetry in all remaining permutations and inversions in a variable partition.

6. The method of claim 1, further comprising:
transforming an integrated circuit design by replacing an instance of the input Boolean function in the integrated circuit design with the NPN canonical form.

7. A computer-implemented method of NPN canonization of an input Boolean function having a single function output and a plurality of function inputs, the method comprising:
based on receiving the input Boolean function, processing circuitry ordering a plurality of variables associated with the plurality of function inputs in a first phase of processing, wherein the ordering includes forming variable partitions of the plurality of variables;
in a second phase of processing, the processing circuitry searching for a Negation-Permutation-Negation (NPN) canonical form of the input Boolean function, wherein the searching includes dynamically limiting a search space by constructing symmetry groups in the variable partitions during the searching;
the processing circuitry storing, in data storage, the NPN canonical form of the input Boolean function; and
the processing circuitry transforming a digital circuit design by replacing a target Boolean function in the digital circuit design with the NPN canonical form.

8. The computer-implemented method of claim 7, wherein the transforming comprises transforming the digital circuit design during logical verification.

9. The computer-implemented method of claim 7, wherein the transforming comprises transforming the digital circuit design during logic synthesis.

10. A computer program product, comprising:
a storage device; and
program code stored within the storage device and executable by processing circuitry of a computer to perform operations including:
receiving an input Boolean function having a single function output and a plurality of variables associated with function inputs;
ordering the variables to form variable partitions;
searching for a Negation-Permutation-Negation (NPN) canonical form of the input Boolean function, wherein the searching includes dynamically limiting a search space by constructing symmetry groups in the variable partitions during the searching; and
storing, in data storage, the NPN canonical form of the input Boolean function.

11. The computer program product of claim 10, wherein:
the ordering includes breaking ordering ties between variables using coefficients for complement sets.

12. The computer program product of claim 10, wherein:
the ordering includes ordering multiple variables among the plurality of variables in accordance with respective impact function values of the multiple variables.

13. The computer program product of claim 10, further comprising:
refining ordering by subdividing variable partitions.

14. The computer program product of claim 10, wherein the searching includes:
terminating the searching based on identifying symmetry in all remaining permutations and inversions in a variable partition.

15. The computer program product of claim 10, further comprising:
transforming an integrated circuit design by replacing an instance of the input Boolean function in the integrated circuit design with the NPN canonical form.

16. A computer program product, comprising:
a storage device; and
program code stored within the storage device and executable by processing circuitry of a computer to perform NPN canonization of an input Boolean function having a single function output and a plurality of function inputs through operations, including:
based on receiving the input Boolean function, ordering a plurality of variables associated with the plurality of function inputs in a first phase of processing, wherein the ordering includes forming variable partitions of the plurality of variables;
in a second phase of processing, searching for a Negation-Permutation-Negation (NPN) canonical form of the input Boolean function, wherein the searching includes dynamically limiting a search space by constructing symmetry groups in the variable partitions during the searching;
storing, in data storage, the NPN canonical form of the input Boolean function; and
transforming a digital circuit design by replacing a target Boolean function in the digital circuit design with the NPN canonical form.

17. The computer program product of claim 16, wherein the transforming comprises transforming the digital circuit design during logical verification.

18. The computer program product of claim 16, wherein the transforming comprises transforming the digital circuit design during logic synthesis.

19. A data processing system, comprising:
processing circuitry;
a storage device coupled to the processing circuitry; and
program code stored within the storage device and executable by the processing circuitry of a data processing system to perform operations including:
receiving an input Boolean function having a single function output and a plurality of variables associated with function inputs;
ordering the variables to form variable partitions;
searching for a Negation-Permutation-Negation (NPN) canonical form of the input Boolean function, wherein the searching includes dynamically limiting a search space by constructing symmetry groups in the variable partitions during the searching; and
storing, in data storage, the NPN canonical form of the input Boolean function.

20. The data processing system of claim 19, wherein:
the ordering includes breaking ordering ties between variables using coefficients for complement sets.

21. The data processing system of claim 19, wherein:
the ordering includes ordering multiple variables among the plurality of variables in accordance with respective impact function values of the multiple variables.

22. The data processing system of claim 19, further comprising:
refining ordering by subdividing variable partitions.

23. The data processing system of claim 19, wherein the searching includes:
terminating the searching based on identifying symmetry in all remaining permutations and inversions in a variable partition.

24. The data processing system of claim 19, further comprising:
transforming a digital circuit design by replacing an instance of the input Boolean function in the integrated circuit design with the NPN canonical form.

25. The data processing system of claim 24, wherein the transforming comprises transforming the digital circuit design during logical verification.
